(19) United States
(12) Patent Application Publication
(10) Pub. No.: US 2026/0291214 A1
(43) Pub. Date: Sep. 24, 2026

(54) IN-VEHICLE DEVICE, INFORMATION PROCESSING METHOD, AND PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Ryosuke MASUDA, Yokkaichi-shi, Mie (JP); Kota ODA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/477,688

(22) PCT Filed: Apr. 4, 2024
(86) PCT No.: PCT/JP2024/013895

§ 371 Date: Oct. 22, 2025

(30) Foreign Application Priority Data
Apr. 24, 2023 (JP) 2023-070984

(51) Int. Cl. H02H 7/22; B60R 16/03

(52) U.S. Cl. CPC H02H 7/22; B60R 16/03

(57) ABSTRACT

An in-vehicle device that controls opening and closing of a plurality of semiconductor fuses provided on a power supply line from a power supply device mounted on a vehicle the in-vehicle device including a control unit configured to perform processing related to opening and closing control of the semiconductor fuses, in which the semiconductor fuses include a main line semiconductor fuse disposed on a main line, and branch line semiconductor fuses respectively arranged on a plurality of branch lines branched from the main line, and the control unit acquires information on a power consumption state of the vehicle, and enables a protection function of the main line semiconductor fuse and disables a protection function of the branch line semiconductor fuses, according to the acquired information on the power consumption state of the vehicle.

### CROSS-REFERENCE TO RELATED APPLICATIONS

This application is the U.S. national stage of PCT/JP2024/013895 filed on Apr. 4, 2024, which claims priority of Japanese Patent Application No. JP 2023-070984 filed on Apr. 24, 2023, the contents of which are incorporated herein.

### TECHNICAL FIELD

The present technology relates to an in-vehicle device, an information processing method, and a program.

### BACKGROUND

A vehicle is equipped with a power supply control device (see, for example, JP 2013-143905 A) that controls power supply from a battery to a load. In the power supply control device described in JP 2013-143905 A, a downstream semiconductor fuse is provided in a current path of a current flowing from the battery to the load, and the power supply from the battery to the load is controlled by switching the downstream semiconductor fuse on or off.

The power supply control device described in JP 2013-143905 A1 does not take into consideration changing the interruption characteristics of the semiconductor fuse in accordance with the power consumption state of the vehicle.

The present disclosure has been made in consideration of the above circumstances, and an object of the present disclosure is to provide an in-vehicle device or the like that can change the interruption characteristics of the semiconductor fuse in accordance with the power consumption state of the vehicle.

### SUMMARY

An in-vehicle device according to an embodiment of the present disclosure is an in-vehicle device that controls opening and closing of a plurality of semiconductor fuses provided on a power supply line from a power supply device mounted on a vehicle, the in-vehicle device including a control unit configured to perform processing related to opening and closing control of the semiconductor fuses, in which the semiconductor fuses include a main line semiconductor fuse disposed on a main line, and branch line semiconductor fuses respectively arranged on a plurality of branch lines branched from the main line, and the control unit acquires information on a power consumption state of the vehicle, and enables a protection function of the main line semiconductor fuse and disables a protection function of the branch line semiconductor fuses, according to the acquired information on the power consumption state of the vehicle.

Effects of the present disclosure According to one aspect of the present disclosure, it is possible to provide an in-vehicle device or the like that changes the interruption characteristics of the semiconductor fuse in accordance with the power consumption state of the vehicle.

### BRIEF DESCRIPTION OF DRAWINGS

FIG. 1 is a schematic diagram illustrating a configuration of an in-vehicle system including an in-vehicle device and the like according to a first embodiment.

FIG. 2 is a block diagram illustrating an internal configuration of the in-vehicle device.

FIG. 3 is an explanatory diagram illustrating setting and the like of interruption characteristics of a main line semiconductor fuse.

FIG. 4 is a flowchart illustrating processing of a control unit of the in-vehicle device.

### DETAILED DESCRIPTION OF PREFERRED EMBODIMENTS

First, embodiments of the present disclosure will be listed and described. In addition, at least some of the embodiments described below may be combined in any combination.

In a first aspect, an in-vehicle device is an in-vehicle device that controls opening and closing of a plurality of semiconductor fuses provided on a power supply line from a power supply device mounted on a vehicle, the in-vehicle device including a control unit configured to perform processing related to opening and closing control of the semiconductor fuses, in which the semiconductor fuses include a main line semiconductor fuse disposed on a main line, and branch line semiconductor fuses respectively arranged on a plurality of branch lines branched from the main line, and the control unit acquires information on a power consumption state of the vehicle, and enables a protection function of the main line semiconductor fuse and disables a protection function of the branch line semiconductor fuses, according to the acquired information on the power consumption state of the vehicle.

In this aspect, the control unit of the in-vehicle device controls the opening and closing of the semiconductor fuse provided on a power supply line from the power supply device, and turns off (opens) the semiconductor fuse to interrupt an overcurrent according to interruption characteristics set in the semiconductor fuse when the overcurrent flows in the power supply line. When an in-vehicle load such as an actuator is connected to the semiconductor fuse, the control unit of the in-vehicle device may control the semiconductor fuse to be on and off (opened and closed) according to a drive request for the in-vehicle load. The semiconductor fuses include the main line semiconductor fuse disposed on the main line and the branch line semiconductor fuses respectively arranged on the plurality of branch lines branched from the main line. In a direction of current flow from the power supply device, the main line semiconductor fuse is located upstream, and the plurality of branch line semiconductor fuses are located downstream of the main line semiconductor fuse. When the overcurrent flows for a predetermined period or more, the semiconductor fuses including the main line semiconductor fuse and the branch line semiconductor fuses are turned off (opened) by the control unit according to the set interruption characteristics, thereby exhibiting the protection function of interrupting the overcurrent. Furthermore, the semiconductor fuses including the main line semiconductor fuse and the branch line semiconductor fuses may be controlled to be opened and closed (on and off) by the control unit to start or stop power supply to the in-vehicle load connected to the semiconductor fuses, thereby controlling the drive of the in-vehicle load (executing a drive control function). The control unit of the in-vehicle device acquires information on the power consumption state of the vehicle by acquiring, for example, a signal from an IG switch or a power switch that controls starting and stopping of the vehicle. Alternatively, the control unit of the in-vehicle device may acquire the information on the power consumption state of the vehicle by acquiring, for example, information on a vehicle speed or information on rotation of an engine or a drive motor from an in-vehicle ECU connected to an in-vehicle network. In this way, the power consumption state of the vehicle may indicate a state related to power consumed by the vehicle depending on whether the vehicle is in a running state (started state) or a parked state (stopped state). The control unit of the in-vehicle device enables (activates) the protection function of the main line semiconductor fuse, and disables (deactivates) protection functions of the branch line semiconductor fuses respectively arranged on the plurality of branch lines based on the information on the power consumption state of the vehicle. That is, depending on the power consumption state of the vehicle, it is possible to protect the main line and the plurality of branch lines branched from the main line by using the protection function of the main line semiconductor fuse, that is, it is possible to ensure safety as an in-vehicle system, and to reduce dark current required to exhibit the protection functions of the branch line semiconductor fuses by disabling the branch line semiconductor fuses. This makes it possible to reduce power consumption of the vehicle, particularly in a standby state (low current consumption mode), such as when parked.

In a second aspect, in the in-vehicle device, when enabling the protection function of the main line semiconductor fuse, the control unit sets interruption characteristics of the main line semiconductor fuse so as to be lower than smoke generation characteristics corresponding to the plurality of branch lines and to be higher than a sum of current values flowing through the plurality of branch lines when the vehicle is in a standby state.

In this aspect, when enabling the protection function of the main line semiconductor fuse, the control unit sets the interruption characteristics of the main line semiconductor fuse so as to be lower than the smoke generation characteristics corresponding to the plurality of branch lines and to be higher than the sum (a combined value) of the current values flowing through the plurality of branch lines when the vehicle is in the standby state. The smoke generation characteristics corresponding to the plurality of branch lines are, for example, the smoke generation characteristics obtained by combining the smoke generation characteristics of the branch lines. Alternatively, the smoke generation characteristics corresponding to the plurality of branch lines may be the smoke generation characteristics obtained by combining the smoke generation characteristics of in-vehicle loads (devices) such as sensors or actuators respectively connected to the branch lines. The sum (combined value) of the current values flowing through the plurality of branch lines when the vehicle is in the standby state may use (apply) a predetermined assumed value as a maximum value of the current value flowing through the main line in the standby state. When the interruption characteristics of the main line semiconductor fuse are, for example, set to an initial value (initial setting) or set to correspond to a normal state (normal current mode) in which a relatively large current flows through the main line, the control unit of the in-vehicle device may change the interruption characteristics from the initial setting so that they are lower than the smoke generation characteristics and higher than the sum (combined value) of the current values. It is assumed as a product specification that a lower limit of the current value determined according to the smoke generation characteristics corresponding to the plurality of branch lines is, for example, about 10 times the sum (combined value) of the current values flowing through the plurality of branch lines when the vehicle is in the standby state. In such a case, a setting range of the interruption characteristics of the main line semiconductor fuse can be made relatively wide by setting an upper limit to the smoke generation characteristics corresponding to the plurality of branch lines and the lower limit to the sum (combined value) of the current values flowing through the plurality of branch lines when the vehicle is in the standby state. In this case, the interruption characteristics of the main line semiconductor fuse in the standby state (low current consumption mode) may be set to near a midpoint (to a midrange) between the smoke generation characteristics corresponding to the plurality of branch lines and the sum (combined value) of the current values flowing through the plurality of branch lines when the vehicle is in the standby state. Therefore, for example, by setting the interruption characteristics of the main line semiconductor fuse to near the midpoint (to the midrange), influence of on-resistance of the main line semiconductor fuse or errors in current value detection when performing interruption control can be reduced, a relatively highly robust control mode can be made, and the safety can be efficiently ensured as the in-vehicle system.

In a third aspect, in the in-vehicle device, the power consumption state of the vehicle includes a normal state and a standby state that consumes less power than the normal state, and the control unit enables the protection function of the main line semiconductor fuse and disables the protection function of the branch line semiconductor fuses when the acquired information on the power consumption state of the vehicle indicates the standby state, and disables the protection function of the main line semiconductor fuse and enables the protection function of the branch line semiconductor fuses when the acquired information on the power consumption state of the vehicle indicates the normal state.

In this aspect, the power consumption state of the vehicle includes the normal state and the standby state (low current consumption mode) that consumes less power than the normal state (normal current mode). The normal state may include, for example, a state in which the vehicle is running (started) and may indicate a state (normal current mode) in which the power consumption of the vehicle is equal to or greater than a predetermined value. The standby state may include, for example, a state in which the vehicle is parked (stopped) and may indicate a state (low current consumption mode) in which the power consumption of the vehicle is less than the predetermined value. When the acquired information on the power consumption state of the vehicle indicates the normal state (when the vehicle is in the normal state), the control unit disables the protection function of the main line semiconductor fuse and enables the protection function of the branch line semiconductor fuses. When the acquired information on the power consumption state of the vehicle indicates the standby state (when the vehicle is in the standby state), the control unit enables the protection function of the main line semiconductor fuse and disables the protection function of the branch line semiconductor fuses. In this way, by complementarily enabling or disabling the main line semiconductor fuse and the branch line semiconductor fuses depending on the power consumption state (the normal state or the standby state) of the vehicle, it is possible to reduce the power consumption required to control the disabled semiconductor fuse (the main line semiconductor fuse or the branch line semiconductor fuses). By providing the main line semiconductor fuse and the branch line semiconductor fuses in which such complementary control is performed, it is possible to improve design freedom and implementation freedom of configuration that reduces the dark current in the standby state (low current consumption mode), such as when parked.

In a fourth aspect, the in-vehicle device further includes a mechanical relay connected in parallel with the main line semiconductor fuse, in which the control unit keeps the mechanical relay in an open state when the vehicle is in the standby state.

In this aspect, the in-vehicle device includes the mechanical relay connected in parallel with the main line semiconductor fuse. That is, the main line forming part of the power supply line extended from a power supply device such as a lead battery includes a main line on which the semiconductor fuse is disposed and a main line on which the mechanical relay is disposed, and a parallel circuit is formed by the main line of the semiconductor fuse and the main line of the mechanical relay. A fuse (melting type fuse) may also be disposed on the main line on which the mechanical relay is disposed. In this case, the mechanical relay and the fuse (melting type fuse) are connected in series on the main line. When the vehicle is in the standby state (low current consumption mode), such as when parked, the control unit of the in-vehicle device keeps the mechanical relay in the open state (off), making it possible to eliminate the need for opening and closing the mechanical relay in the standby state, thereby improving durability (usable period or parts life) of the mechanical relay.

In a fifth aspect, in the in-vehicle device, the control unit acquires a current value flowing through the main line on which the main line semiconductor fuse is disposed, and performs interruption control on the main line semiconductor fuse having interruption characteristics set according to the standby state, based on the acquired current value.

In this aspect, the control unit of the in-vehicle device acquires the current value flowing through the main line, for example, from a current detection unit configured to detect the current flowing through the main line on which the main line semiconductor fuse is disposed. The current detection unit includes, for example, a shunt resistor provided on the main line on which the main line semiconductor fuse is disposed. Alternatively, if the main line semiconductor fuse includes, for example, an intelligent power device (IPD), the current detection unit built in the IPD may be used. The control unit of the in-vehicle device performs the interruption control on the main line semiconductor fuse in accordance with the interruption characteristics set according to the standby state based on the current value detected by the current detection unit. The interruption characteristics may be illustrated as an interruption characteristic curve on a characteristics graph with a vertical axis representing the current value (A) and a horizontal axis representing an elapsed time(S), and the interruption characteristic curve may be stored in a storage unit. The control unit of the in-vehicle device refers to the interruption characteristic curve stored in the storage unit and interrupts the current (overcurrent) flowing through the main line by opening (turning off) the main line semiconductor fuse according to the current value detected by the current detection unit and the elapsed time. In the standby state (low current consumption mode), such as when parked, even if the protection functions of the branch line semiconductor fuses connected directly to in-vehicle devices such as individual actuators are disabled, the interruption control can be performed using the main line semiconductor fuse having the interruption characteristics set according to the standby state. This makes it possible to efficiently ensure the safety as the in-vehicle system while reducing the dark current in the standby state (low current consumption mode).

In a sixth aspect, a program is a program that causes a computer, that controls opening and closing of a plurality of semiconductor fuses provided on a power supply line from a power supply device mounted on a vehicle, to execute processing, in which the semiconductor fuses include a main line semiconductor fuse disposed on a main line, and branch line semiconductor fuses respectively arranged on a plurality of branch lines branched from the main line, and the program causes the computer to execute processing for acquiring information on a power consumption state of the vehicle, and enabling a protection function of the main line semiconductor fuse and disabling a protection function of the branch line semiconductor fuses, according to the acquired information on the power consumption state of the vehicle.

In this aspect, it is possible to provide the program that causes the computer to function as the in-vehicle device that changes the interruption characteristics of the main line semiconductor fuse in accordance with the power consumption state of the vehicle.

In a seventh aspect, an information processing method is an information processing method that causes a computer, that controls opening and closing of a plurality of semiconductor fuses provided on a power supply line from a power supply device mounted on a vehicle, to execute processing, in which the semiconductor fuses include a main line semiconductor fuse disposed on a main line, and branch line semiconductor fuses respectively arranged on a plurality of branch lines branched from the main line, and the information processing method causes the computer to execute processing for acquiring information on a power consumption state of the vehicle, and enabling a protection function of the main line semiconductor fuse and disabling a protection function of the branch line semiconductor fuses, according to the acquired information on the power consumption state of the vehicle.

In this aspect, it is possible to provide the information processing method that causes the computer to function as the in-vehicle device that changes the interruption characteristics of the main line semiconductor fuse in accordance with the power consumption state of the vehicle.

The present disclosure will be specifically described based on the drawings illustrating the embodiments. An in-vehicle device 1 according to the embodiments of the present disclosure will be described below with reference to the drawings. Note that the present disclosure is not limited to these examples, but is defined by the scope of the claims, and is intended to include all modifications within the meaning and scope equivalent to the claims.

### First Embodiment

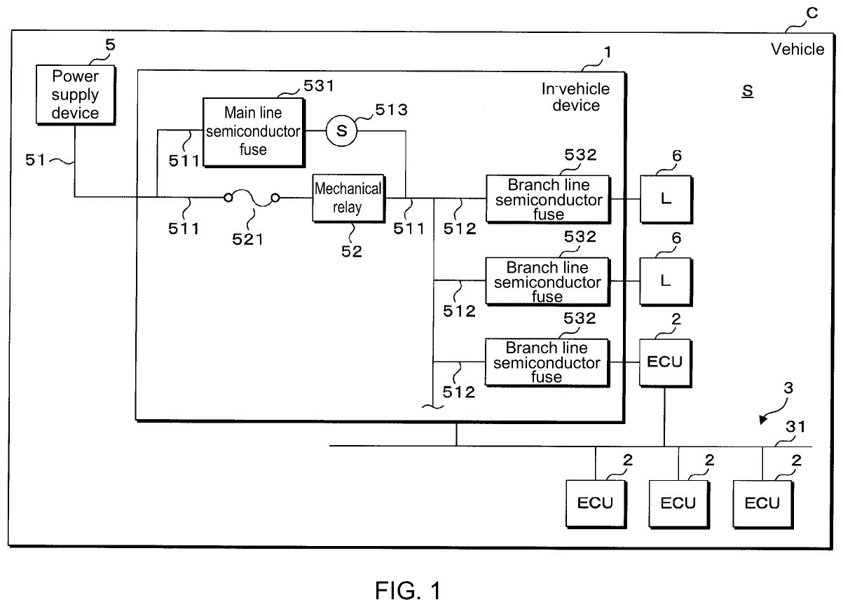

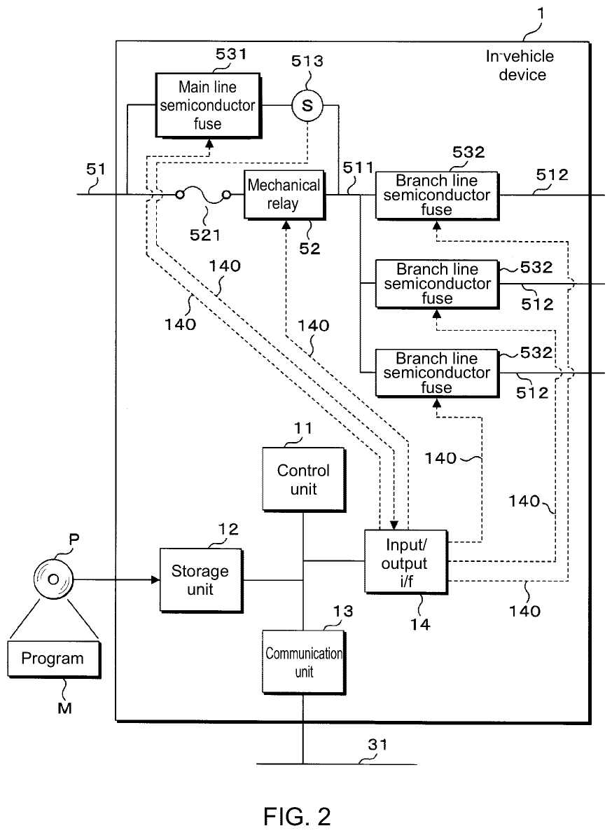

Hereinafter, an embodiment will be described with reference to the drawings. FIG. 1 is a schematic diagram illustrating a configuration of an in-vehicle system S including the in-vehicle device 1 and the like according to a first embodiment. FIG. 2 is a block diagram illustrating an internal configuration of the in-vehicle device 1. The in-vehicle system S includes an in-vehicle device 1 mounted on a vehicle C, an in-vehicle ECU 2, and an in-vehicle network 3 that communicatively connects them. The in-vehicle network 3 includes a plurality of communication lines 31. When communication in the in-vehicle network 3 is performed according to a communication protocol of, for example, a controller area network (CAN) or CAN-FD, the communication line 31 corresponds to a CAN bus.

The vehicle C is equipped with a power supply device 5 including the lead battery, an alternator, a secondary battery, or the like. The power supply device 5 and the in-vehicle device 1 are connected by a power supply line 51. The power supply device 5 and the in-vehicle device 1 are not limited to being directly connected by the power supply line 51, but may be indirectly connected with an electrical box (a junction box) such as a relay box or a fuse 521 box interposed between the power supply device 5 and the in-vehicle device 1.

The in-vehicle device 1 and a plurality of in-vehicle loads 6 or the in-vehicle ECU 2 are connected by the power supply line 51 (branch lines 512), and the in-vehicle device 1 distributes power to the plurality of in-vehicle loads 6 or the in-vehicle ECU 2. That is, the in-vehicle device 1 functions as a power distribution device that distributes the power supplied from the power supply device 5 through the power supply line 51 to the plurality of in-vehicle loads 6 or the in-vehicle ECU 2 that are arranged downstream in the direction of the current flow.

The power supply line 51 extending from the power supply device 5 is connected to a main line semiconductor fuse 531 provided in the in-vehicle device 1. The power supply line 51 is located inside the in-vehicle device 1 and includes a main line 511 to which the main line semiconductor fuse 531 is connected, and the plurality of branch lines 512 branched from the main line 511. The main line 511 includes a main line 511 to which the main line semiconductor fuse 531 is connected, and a main line 511 to which the fuse 521 (melting type fuse) and a mechanical relay 52 are connected, and the main line 511 of the main line semiconductor fuse 531 and the main line 511 of the fuse 521 (melting type fuse) and the like form the parallel circuit. That is, the main line semiconductor fuse 531 is connected in parallel with the fuse 521 (melting type fuse) and the mechanical relay 52.

A current detection unit 513 is disposed between the main line semiconductor fuse 531 and a branch point where the main line 511 branches into the plurality of branch lines 512. The current detection unit 513 may be provided on the main line 511 on which the main line semiconductor fuse 531 is disposed. The current detection unit 513 periodically or steadily detects a value of the current (the current value) flowing through the main line semiconductor fuse 531. The current detection unit 513 is a current sensor including, for example, the shunt resistor, and outputs the detected current value to a control unit 11 of the in-vehicle device 1. Alternatively, the current detection unit 513 may be a current sensor (main line current sensor) built in the intelligent power device (IPD) constituting the main line semiconductor fuse 531.

Branch line semiconductor fuses 532 are respectively arranged on the plurality of branch lines 512. The branch line semiconductor fuse 532 includes, for example, the intelligent power device (IPD). The branch line semiconductor fuses 532 respectively arranged on the branch lines 512 is arranged downstream of the main line semiconductor fuse 531 in the direction of the current flow from the power supply line 51. The in-vehicle load 6 or the in-vehicle ECU 2 is connected to the branch line 512 located downstream of the branch line semiconductor fuse 532 in the direction of the current flow from the power supply line 51.

The in-vehicle load 6 is, for example, the actuator such as a car air conditioner, a lamp, or a drive motor. The in-vehicle ECU 2 includes a microcomputer or the like having a communication function, and performs predetermined arithmetic processing based on detection values from the sensors or output values from various switches. Power supply to the in-vehicle loads 6 and the like is started or cut off in response to the opening and closing control (on/off control) of the branch line semiconductor fuses 532 arranged on the branch lines 512, and thus the in-vehicle loads 6 and the like started or stopped. The in-vehicle device 1 functions as a power supply control device that controls starting or stopping of the in-vehicle loads 6 and the like by controlling the opening and closing (on and off) of the branch line semiconductor fuses 532.

The in-vehicle device 1 functions as the power supply control device that controls starting or stopping of the in-vehicle ECU 2, and may be a device having a relay function, such as a CAN gateway. Alternatively, the in-vehicle device 1 may be an integrated ECU (a vehicle computer) that controls an entire vehicle C in an integrated manner and has the relay function. Alternatively, the in-vehicle device 1 may be individual ECUs connected under the integrated ECU and respectively arranged in areas of the vehicle C. Alternatively, the in-vehicle device 1 may be configured as a body ECU or the like that controls body actuators of the vehicle C. Alternatively, the in-vehicle device 1 may be a Power Lan Box (PLB) that also functions as a power distribution device that distributes and relays power output from the power supply device 5 such as a secondary battery and supplies power to in-vehicle devices such as actuators, in addition to relaying communication. The in-vehicle device 1 may be connected to in-vehicle devices such as various switches, sensors, or actuators.

The in-vehicle device 1 includes the control unit 11, a storage unit 12, a communication unit 13, and an input/output I/F 14. The control unit 11 includes a central processing unit (CPU), a micro processing unit (an MPU), or the like, and is configured to perform various control processes, arithmetic processes, and the like by reading and executing a control program P (program product) and data stored in the storage unit 12 in advance.

The storage unit 12 includes a volatile memory element such as a random access memory (RAM), a non-volatile memory element such as a read only memory (ROM), an electrically erasable programmable ROM (EEPROM), or flash memory, or a combination of these storage devices, and stores the control program P (program product) and data to be referenced during processing in advance. The control program P (program product) stored in the storage unit 12 may be a control program P (program product) read from a recording medium M readable by the in-vehicle device 1. Alternatively, the control program P may be a control program P (program product) downloaded from an external computer (not illustrated) connected to a communication network (not illustrated) and stored in the storage unit 12.

The communication unit 13 is an input/output interface that uses the communication protocol such as CAN, CAN-FD, or Ethernet (registered trademark), and the control unit 11 mutually communicates with the in-vehicle ECU 2 connected to the in-vehicle network 3 through the communication unit 13. The in-vehicle device 1 may be provided with a plurality of the communication units 13.

The input/output I/F 14 is, for example, a communication interface for serial communication. The input/output I/F 14 includes a plurality of terminals (output terminals), and the terminals are respectively connected to signal lines 140 respectively extending to the main line semiconductor fuse 531, the current detection unit 513, the mechanical relay 52, and the branch line semiconductor fuses 532. The signal line 140 includes, for example, a serial cable, a wire harness, or a conductive cable (direct wire) that transmits only one signal.

The main line semiconductor fuse 531 includes, for example, a field effect transistor (FET). Alternatively, the main line semiconductor fuse 531 may include the IPD including the FET or the like. The control unit 11 of the in-vehicle device 1 performs the interruption control of the main line semiconductor fuse 531 in accordance with the interruption characteristics of the main line semiconductor fuse 531 based on the current value output from the current detection unit 513. As will be described in detail later, the interruption characteristics of the main line semiconductor fuse 531 are variably set in accordance with the power consumption state (the normal state or the standby state) of the vehicle C.

The branch line semiconductor fuse 532 includes, for example, the field effect transistor (FET). Alternatively, the branch line semiconductor fuse 532 may include the IPD including the FET or the like. The control unit 11 of the in-vehicle device 1 performs the interruption control of the branch line semiconductor fuse 532 in accordance with the interruption characteristics of the branch line semiconductor fuse 532, for example, based on the current value output from the current sensor (branch line 512 current sensor) or the like built in the IPD the IPD that constitutes the branch line semiconductor fuse 532.

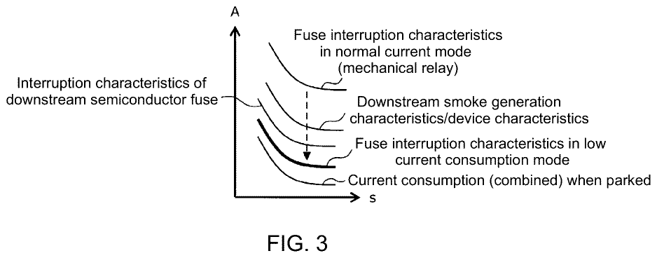

FIG. 3 is an explanatory diagram illustrating setting and the like of the interruption characteristics of the main line semiconductor fuse 531. The interruption characteristics of the main line semiconductor fuse 531 and the like and the smoke generation characteristics of the branch line 512 are both illustrated on the characteristics graph with the vertical axis representing the current value (A) and the horizontal axis representing the elapsed time(S).

The interruption characteristics define a time (equivalent to a melting time of the fuse 521) until the current is interrupted when the current (overcurrent) exceeding a rated current value of the semiconductor fuse such as the main line semiconductor fuse 531 or the branch line semiconductor fuse 532 flows. When the value of the current flowing through the semiconductor fuse is equal to or less than the rated current value, the semiconductor fuse will not be interrupted and will continue to pass a current equal to or less than the rated current value.

The main line semiconductor fuse 531 is set with the interruption characteristics corresponding to the standby state (low current consumption mode). The branch line semiconductor fuse 532 is set with the interruption characteristics corresponding to the normal state (normal current mode). Details of the standby state (low current consumption mode) and the normal state (normal current mode) will be described later.

The interruption characteristics of the main line semiconductor fuse 531 may be set by the control unit 11 of the in-vehicle device 1 as a variable characteristic value so that the current value can be moved (shifted) up and down in a vertical axis direction, that is, for the same elapsed time. When the interruption characteristics of the main line semiconductor fuse 531 are high, the rated current value is also high and the time until interruption in response to the overcurrent is also long. When the interruption characteristics of the main line semiconductor fuse 531 are low, the rated current value is also low and the time until the interruption in response to the overcurrent is short. That is, product (integrated current value) of the current value (overcurrent value) and the time until the interruption goes up and down depending on a level of the interruption characteristics.

The interruption characteristics of the main line semiconductor fuse 531 in the standby state (fuse interruption characteristics in low current consumption mode) are set to be lower than the combined smoke generation characteristics (combined value) of the branch lines 512 into which the main line 511 is branched or the combined smoke generation characteristics (device characteristics) of the in-vehicle loads connected to the branch lines 512 (downstream smoke generation characteristics/device characteristics), for example, by applying a predetermined offset value to the combined smoke generation characteristics of the branch lines 512 or the combined smoke generation characteristics. Furthermore, the interruption characteristics of the main line semiconductor fuse 531 in the standby state (fuse interruption characteristics in low current consumption mode) are set to be higher than the sum (for example, a combined value of the current consumption when parked) of the current values flowing through the branch lines 512 into which the main line 511 is branched in the standby state.

That is, the interruption characteristics of the main line semiconductor fuse 531 in the standby state (fuse interruption characteristics in low current consumption mode) are set to be lower than the smoke generation characteristics corresponding to the plurality of branch lines 512 and to be higher than the sum (combined value) of the current values flowing through the plurality of branch lines 512 when the vehicle C is in the standby state. Thus, in the standby state, the interruption control can be performed in accordance with the interruption characteristics of the main line semiconductor fuse 531 without exceeding allowable values defined by the smoke generation characteristics or the device characteristics of the plurality of branch lines 512 and the like, and the plurality of branch lines 512 and the like can be reliably protected from the overcurrent.

The interruption characteristics of the main line semiconductor fuse 531 in the standby state (fuse interruption characteristics in low current consumption mode) thus set are also set to be lower than the interruption characteristics of the fuse 521 (melting type fuse) in the normal state (fuse interruption characteristics in normal current mode (mechanical relay)). In the normal state, the interruption characteristics of the main line semiconductor fuse 531 may be set (changed) to be the same as the interruption characteristics of the fuse 521 (melting type fuse) (fuse interruption characteristics in normal current mode (mechanical relay)). In this case, the protection function of the main line semiconductor fuse 531 is always enabled, and the interruption characteristics of the main line semiconductor fuse 531 are changed to either the interruption characteristics in the standby state or the interruption characteristics in the normal state depending on the power consumption state of the vehicle C. Thus, in the normal state, the fuse 521 (melting type fuse) and the mechanical relay 52 are connected in parallel with the main line semiconductor fuse 531 and have the same interruption characteristics, thereby achieving redundancy through a parallel circuit made up of the fuse 521 (melting type fuse) and the mechanical relay 52, and the main line semiconductor fuse 531. The interruption characteristics of the main line semiconductor fuse 531 in the standby state (fuse interruption characteristics in low current consumption mode) are further set to be lower than the interruption characteristics of the branch line semiconductor fuses 532 in the normal state (interruption characteristics of downstream semiconductor fuses).

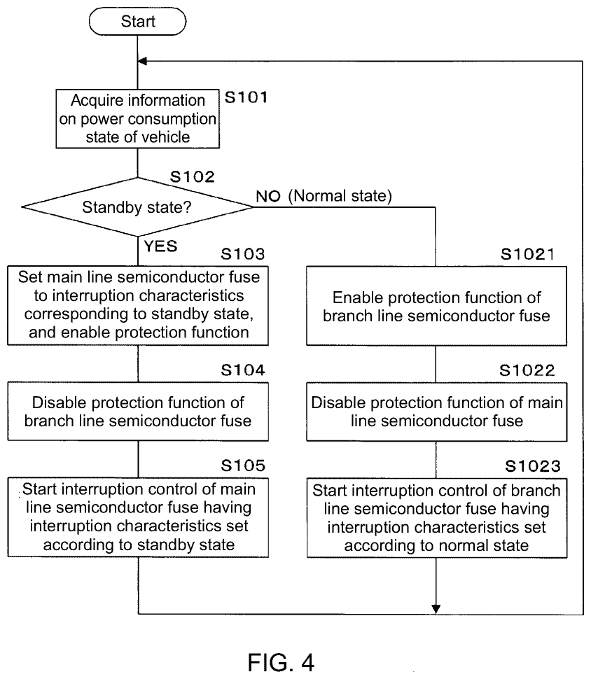

FIG. 4 is a flowchart illustrating the processing of the control unit 11 of the in-vehicle device 1. The control unit 11 of the in-vehicle device 1 steadily performs the following processing when the vehicle C is stopped or started.

The control unit 11 of the in-vehicle device 1 acquires information on the power consumption state of the vehicle C (S101). The control unit 11 of the in-vehicle device 1 determines whether the vehicle C is in the started state or the stopped state, for example, by acquiring the signal from the IG switch or the power switch that controls the starting and stopping of the vehicle C. Alternatively, the control unit 11 of the in-vehicle device 1 may determine whether the vehicle speed is zero or not, for example, by acquiring the information on the vehicle speed, the information on the rotation of the engine or the drive motor, from the in-vehicle ECU 2 connected to the in-vehicle network 3. The control unit 11 of the in-vehicle device 1 may derive (acquire) the information on the power consumption state of the vehicle C depending on whether the vehicle C is in the running state (started state) or the parked state (stopped state). That is, the information on the power consumption state of the vehicle C includes information indicating whether the vehicle C is in the started or stopped state.

The power consumption state of the vehicle C includes the normal state (normal current mode) and the standby state (low current consumption mode) in which the power consumption is lower than the normal state. The normal state includes, for example, a state in which the vehicle C is running (started) and indicates a state (normal current mode) in which the power consumption of the vehicle C is equal to or greater than a predetermined value. The standby state includes, for example, a state in which the vehicle C is parked (stopped) and indicates a state (low current consumption mode) in which the power consumption of the vehicle C is less than a predetermined value.

Alternatively, the normal state (normal current mode) may include the state in which the vehicle C is running or a parked state with an occupant on board, and may indicate a state in which the engine is running and any in-vehicle load is driven. The standby state may include a state in which the vehicle C is parked with no occupants on board, and may indicate a state in which the engine is not running, and any in-vehicle load is not driven. However, the in-vehicle load may not be in a completely stopped state, but may be waiting to be immediately drivable, for example, when a specified start signal is received. That is, the standby state also includes a state in which such an in-vehicle load or in-vehicle ECU 2 waiting to be immediately drivable is present.

The storage unit 12 of the in-vehicle device 1 may store state definition information that defines a correspondence between the power consumption state (the normal state or the standby state) and the state of the vehicle C, the in-vehicle load, or the like, for example, in a table format (lookup table). The control unit 11 of the in-vehicle device 1 may derive (acquire) the power consumption state of the vehicle C by referring to the state definition information (lookup table). The control unit 11 of the in-vehicle device 1 acquires the information by deriving the information on the power consumption state of the vehicle C based on communication data such as signals received from various switches in this way, or messages received from the in-vehicle ECU 2 that is communicatively connected via the in-vehicle network 3.

The control unit 11 of the in-vehicle device 1 determines whether the vehicle C is in the standby state based on the information on the power consumption state of the vehicle C (S102). The control unit 11 of the in-vehicle device 1 determines whether the vehicle C is in the standby state (low current consumption mode) or in the normal state (normal current mode) based on the acquired information on the power consumption state of the vehicle C. The control unit 11 of the in-vehicle device 1 may store the determination result in the storage unit 12 in association with a time when determination processing was performed (determination time point).

If the vehicle C is in the standby state (S102: YES), the control unit 11 of the in-vehicle device 1 sets the main line semiconductor fuse 531 to the interruption characteristics corresponding to the standby state and enables the protection function (S103). If the vehicle C is in the standby state (low current consumption mode), the control unit 11 of the in-vehicle device 1 sets the main line semiconductor fuse 531 to the interruption characteristics corresponding to the standby state. The interruption characteristics of the main line semiconductor fuse 531 corresponding to the standby state are shown, for example, as the interruption characteristic curve on the characteristics graph and stored in the storage unit 12.

The control unit 11 of the in-vehicle device 1 may enable the protection function of the main line semiconductor fuse 531 by applying the interruption characteristics when executing an application or the like corresponding to the protection function of the main line semiconductor fuse 531. Alternatively, when the main line semiconductor fuse 531 includes, for example, the intelligent power device (IPD), the control unit 11 may enable the protection function of the main line semiconductor fuse 531 by transmitting, to the IPD (main line semiconductor fuse 531), a signal for applying the interruption characteristics corresponding to the standby state and starting (enabling) the protection function.

The control unit 11 of the in-vehicle device 1 may further keep (fix) the mechanical relay 52 in the open state (off) when the vehicle C is in the standby state (low current consumption mode). When the vehicle C is in the standby state (low current consumption mode), by keeping (fixing) the mechanical relay 52 in the open state (off), it is possible to eliminate the need for opening and closing the mechanical relay 52 in the standby state, thereby improving the durability (usable period or parts life) of the mechanical relay 52.

The control unit 11 of the in-vehicle device 1 disables the protection function of the branch line semiconductor fuse 532 (S104). The control unit 11 of the in-vehicle device 1 may disable the protection function of the branch line semiconductor fuse 532, for example, by stopping an application or the like corresponding to the protection function of the branch line semiconductor fuse 532. Alternatively, when the branch line semiconductor fuse 532 includes, for example, the intelligent power device (IPD), the control unit 11 may disable the protection function of the branch line semiconductor fuse 532 by transmitting a signal for stopping (disabling) the protection function to the IPD (branch line semiconductor fuse 532).

By disabling the protection function of the branch line semiconductor fuse 532 in this way, it is possible to reduce the power consumption required to exhibit (execute) the protection function. That is, as the number (three in the present embodiment) of the branch line semiconductor fuses 532 having protection functions disabled in the standby state (low current consumption mode) increases, an effect of reducing the power consumption can be improved.

When enabling or disabling the protection functions of the main line semiconductor fuse 531 and the branch line semiconductor fuses 532, the control unit 11 of the in-vehicle device 1 enables the protection function of the main line semiconductor fuse 531 and then disables the protection functions of the branch line semiconductor fuses 532. Thus, when the vehicle C transitions to the standby state, by first enabling the protection function of the main line semiconductor fuse 531, it is possible to reliably prevent occurrence of a period during which the protection functions of both the main line semiconductor fuse 531 and the branch line semiconductor fuse 532 are disabled.

The control unit 11 of the in-vehicle device 1 starts the interruption control of the main line semiconductor fuse 531 having the interruption characteristics set according to the standby state (S105). The interruption characteristics set in the main line semiconductor fuse 531 according to the standby state are lower than the smoke generation characteristics according to the plurality of branch lines 512 and higher than the sum (combined value) of the current values flowing through the plurality of branch lines 512 when the vehicle C is in the standby state. When the current value (overcurrent) determined by the smoke generation characteristics according to the plurality of branch lines 512 is set as the upper limit and the sum (combined value) of the current values flowing through the plurality of branch lines 512 when the vehicle C is in the standby state is set as the lower limit, a range of current values determined by the upper and lower limits is relatively wide. The interruption characteristics of the main line semiconductor fuse 531 in the standby state only need to fall within the range of current values determined by the upper and lower limits, and thus a degree of freedom in setting the interruption characteristics can be increased. Thus, when setting the interruption characteristics of the main line semiconductor fuse 531 in the standby state, the influence of the on-resistance of the main line semiconductor fuse 531 or errors in the current value detection when performing the interruption control can be reduced, a relatively highly robust control mode can be made, and the safety can be efficiently ensured as the in-vehicle system S.

The control unit 11 of the in-vehicle device 1 acquires the current value of the current flowing through the main line 511 from the current detection unit 513 (main line current sensor) that is connected in series to the main line semiconductor fuse 531 and disposed on the main line 511. Alternatively, the control unit 11 may acquire the current value of the current flowing through the main line 511 from the main line current sensor built in the IPD that constitutes the main line semiconductor fuse 531. Based on the interruption characteristic curve (interruption characteristics corresponding to the standby state) stored in the storage unit 12, when the current value corresponding to the overcurrent flows for a predetermined period or more, the control unit 11 of the in-vehicle device 1 opens (turns off) the main line semiconductor fuse 531 and interrupts the current (overcurrent) flowing through the main line 511.

If the vehicle C is not in the standby state (S102: NO), that is, when the vehicle C is in the normal state, the control unit 11 of the in-vehicle device 1 enables the protection function of the branch line semiconductor fuse 532 (S1021). When the vehicle C is not in the standby state, that is, when the vehicle C is in the normal state (normal current mode), the control unit 11 of the in-vehicle device 1 may enable the protection function of the branch line semiconductor fuse 532 by executing the application or the like corresponding to the protection function of the branch line semiconductor fuse 532. Alternatively, when the branch line semiconductor fuse 532 includes, for example, the intelligent power device (IPD), the control unit 11 may enable the protection function of the branch line semiconductor fuse 532 by transmitting a signal to the IPD (branch line semiconductor fuse 532) for starting (enabling) the protection function.

The control unit 11 of the in-vehicle device 1 disables the protection function of the main line semiconductor fuse 531 (S1022). The control unit 11 of the in-vehicle device 1 may disable the protection function of the main line semiconductor fuse 531 by stopping the application or the like corresponding to the protection function of the main line semiconductor fuse 531. Alternatively, when the main line semiconductor fuse 531 includes, for example, the intelligent power device (IPD), the control unit 11 may disable the protection function of the main line semiconductor fuse 531 by transmitting the signal for stopping (disabling) the protection function to the IPD (main line semiconductor fuse 531).

When enabling or disabling the protection functions of the main line semiconductor fuse 531 and the branch line semiconductor fuse 532, the control unit 11 of the in-vehicle device 1 enables the protection function of the branch line semiconductor fuse 532 and then disables the protection function of the main line semiconductor fuse 531. Thus, when the vehicle C transitions to the normal state, by first enabling the protection function of the branch line semiconductor fuse 532, it is possible to reliably prevent the occurrence of the period during which the protection functions of both the main line semiconductor fuse 531 and the branch line semiconductor fuse 532 are disabled.

Although the control unit 11 of the in-vehicle device 1 has been described as disabling the protection function of the main line semiconductor fuse 531 when the vehicle C is not in the standby state (in the normal state), the control unit 11 of the in-vehicle device 1 is not limited to this. When the vehicle C is in the normal state, the control unit 11 of the in-vehicle device 1 may change (set) the interruption characteristics of the main line semiconductor fuse 531 to interruption characteristics corresponding to the normal state, that is, the same interruption characteristics as the mechanical relay 52 and the fuse 521 (melting type fuse). The main line semiconductor fuse 531 is connected in parallel (constitutes the parallel circuit) with the mechanical relay 52 and the fuse 521 (melting type fuse), so that even when a fault occurs in either circuit, the other circuit can continue the protection function in the normal state of the vehicle C.

The control unit 11 of the in-vehicle device 1 starts the interruption control for the branch line semiconductor fuses 532 having the interruption characteristics set according to the normal state (S1023). The interruption characteristics of the branch line semiconductor fuses 532 respectively arranged on the plurality of branch lines 512 are, for example, stored in the storage unit 12 as the interruption characteristic curve. The control unit 11 of the in-vehicle device 1 starts the interruption control for the branch line semiconductor fuses 532 in accordance with the interruption characteristic curve stored in the storage unit 12.

The control unit 11 of the in-vehicle device 1 acquires the current value of the branch line 512 from a branch line current sensor disposed on the branch line 512 or the current sensor built in the IPD that constitutes the branch line semiconductor fuse 532. Based on the interruption characteristic curve stored in the storage unit 12, when the current value corresponding to the overcurrent flows for the predetermined period or more, the control unit 11 of the in-vehicle device 1 opens (turns off) the branch line semiconductor fuse 532 and interrupts the current (overcurrent) flowing through the branch line 512.

After executing S105 or S1023, the control unit 11 of the in-vehicle device 1 performs loop processing so as to perform processing from S101 again. Thus, the control unit 11 of the in-vehicle device 1 can periodically or steadily continue processing of acquiring (deriving) the information on the power consumption state of the vehicle C, and continuously perform processing of determining whether the current state of the vehicle C is the standby state (low current consumption mode) or the normal state (normal current mode).

The embodiments disclosed herein are illustrative in all respects and should not be considered as limiting. The scope of the present disclosure is indicated not by the meaning described above but by the claims, and is intended to include all modifications within the meaning and scope of the claims.

Multiple claims described in the claims can be combined with each other, regardless of the form of reference. The claims may contain multiple dependent claims that depend on multiple claims. The claims may contain multiple dependent claims that depend on multiple dependent claims. Even when a multiple dependent claim that depends on a multiple dependent claim is not described, this does not limit description of multiple dependent claims that depend on a multiple dependent claim.

1. An in-vehicle device that controls opening and closing of a plurality of semiconductor fuses provided on a power supply line from a power supply device mounted on a vehicle, the in-vehicle device comprising
a control unit configured to perform processing related to opening and closing control of the semiconductor fuses, wherein
the semiconductor fuses include a main line semiconductor fuse disposed on a main line, and branch line semiconductor fuses respectively arranged on a plurality of branch lines branched from the main line, and
the control unit acquires information on a power consumption state of the vehicle, and enables a protection function of the main line semiconductor fuse and disables a protection function of the branch line semiconductor fuses, according to the acquired information on the power consumption state of the vehicle.

2. The in-vehicle device according to claim 1, wherein when enabling the protection function of the main line semiconductor fuse, the control unit sets interruption characteristics of the main line semiconductor fuse so as to be lower than smoke generation characteristics corresponding to the plurality of branch lines and to be higher than a sum of current values flowing through the plurality of branch lines when the vehicle is in a standby state.

3. The in-vehicle device according to claim 2, wherein
the power consumption state of the vehicle includes a normal state and a standby state that consumes less power than the normal state, and
the control unit enables the protection function of the main line semiconductor fuse and disables the protection function of the branch line semiconductor fuses when the acquired information on the power consumption state of the vehicle indicates the standby state, and disables the protection function of the main line semiconductor fuse and enables the protection function of the branch line semiconductor fuses when the acquired information on the power consumption state of the vehicle indicates the normal state.

4. The in-vehicle device according to claim 2, further comprising a mechanical relay connected in parallel with the main line semiconductor fuse, wherein
the control unit keeps the mechanical relay in an open state when the vehicle is in the standby state.

5. The in-vehicle device according to claim 2, wherein the control unit acquires a current value flowing through the main line on which the main line semiconductor fuse is disposed, and performs interruption control on the main line semiconductor fuse having interruption characteristics set according to the standby state, based on the acquired current value.

6. A program that causes a computer, that controls opening and closing of a plurality of semiconductor fuses provided on a power supply line from a power supply device mounted on a vehicle, to execute processing, wherein
the semiconductor fuses include a main line semiconductor fuse disposed on a main line, and branch line semiconductor fuses respectively arranged on a plurality of branch lines branched from the main line, and
the program causes the computer to execute processing for acquiring information on a power consumption state of the vehicle, and enabling a protection function of the main line semiconductor fuse and disabling a protection function of the branch line semiconductor fuses, according to the acquired information on the power consumption state of the vehicle.

7. An information processing method that causes a computer, that controls opening and closing of a plurality of semiconductor fuses provided on a power supply line from a power supply device mounted on a vehicle, to execute processing, wherein
the semiconductor fuses include a main line semiconductor fuse disposed on a main line, and branch line semiconductor fuses respectively arranged on a plurality of branch lines branched from the main line, and
the information processing method causes the computer to execute processing for acquiring information on a power consumption state of the vehicle, and enabling a protection function of the main line semiconductor fuse and disabling a protection function of the branch line semiconductor fuses, according to the acquired information on the power consumption state of the vehicle.
